(19) United States
(12) Patent Application Publication
(10) Pub. No.: US 2026/0238724 A1
(43) Pub. Date: Aug. 13, 2026

(54) INFORMATION PROCESSING APPARATUS, SYSTEM, AND NON-TRANSITORY COMPUTER-READABLE STORAGE MEDIUM

(71) Applicant: RevComm Inc., Tokyo (JP)

(72) Inventors: Takekatsu HIRAMURA, Chiyoda-ku (JP); Tsunemasa AKASAKA, Chiyoda-ku (JP)

(73) Assignee: RevComm Inc., Tokyo (JP)

(21) Appl. No.: 19/637,417

(22) Filed: Apr. 2, 2026

Related U.S. Application Data
(63) Continuation of application No. PCT/JP2023/044608, filed on Dec. 13, 2023.

(51) Int. Cl. H04M 3/51; H04M 11/00

(52) U.S. Cl. CPC H04M 3/5141; H04M 11/00

(57) ABSTRACT

An information processing apparatus for processing information on an interaction, the apparatus including a code reader; and processing circuitry configured to: read a two-dimensional code with the code reader and identify a predetermined URL based on the two-dimensional code; initiate a call to a predetermined call destination associated with the identified predetermined URL; and transmit additional information based on the identified predetermined URL, the additional information not including voice information related to a call of a first user of the information processing apparatus.

### CROSS-REFERENCE TO RELATED APPLICATIONS

This application is based upon and claims the benefit of priority from the prior PCT Patent Application No. PCT/JP 2023/044608, filed Dec. 13, 2023 the entire contents of which are incorporated herein by reference.

### FIELD

The present disclosure relates to an information processing apparatus, system, and a non-transitory computer-readable storage medium.

### BACKGROUND

Online calling services are known.

Conventional System discloses a technology for making a call using a web content.

There is a problem that additional information related to the call cannot be transmitted to the call recipient.

### SUMMARY

Therefore, the present disclosure is intended to solve the above-mentioned problem, and its object is to provide a technology for initiating a call to a predetermined call destination while also transmitting additional information related to the call to the call destination.

### BRIEF DESCRIPTION OF THE DRAWINGS

FIG. 1 is a block diagram showing a functional configuration of a system 1.

FIG. 2 is a block diagram showing a functional configuration of a server 10.

FIG. 3 is a block diagram showing a functional configuration of a first user terminal 20.

FIG. 4 is a block diagram showing a functional configuration of a second user terminal 30.

FIG. 5 shows a data structure of a user table 1012.

FIG. 6 shows a data structure of a group table 1013.

FIG. 7 shows a data structure of an interaction table 1014.

FIG. 8 shows a data structure of a label table 1015.

FIG. 9 shows a data structure of a voice segment table 1016.

FIG. 10 shows a data structure of a code table 1021.

FIG. 11 shows a data structure of a contact table 1022.

FIG. 12 is a flowchart showing an operation of inquiry processing.

FIG. 13 is a screen example showing an operation of a call initiation page in the inquiry processing.

FIG. 14 is a block diagram showing a basic hardware configuration of a computer 90.

### DETAILED DESCRIPTION

In general, according to one embodiment, an information processing apparatus for processing information on an interaction, the apparatus comprising: a code reader; and processing circuitry configured to: read a two-dimensional code with the code reader and identify a predetermined URL based on the two-dimensional code; initiate a call to a predetermined call destination associated with the identified predetermined URL; and transmit additional information based on the identified predetermined URL, the additional information not including voice information related to a call of a first user of the information processing apparatus.

Hereinafter, an embodiment of the present disclosure will be described with reference to the drawings. In all drawings illustrating the embodiment, common constituent elements are denoted by the same reference numeral, and repeated descriptions will be omitted. It should be noted that the following embodiment does not unduly limit the contents of the present disclosure described in the claims. In addition, not all of the constituent elements described in the present embodiment are essential constituent elements of the present disclosure. Furthermore, each figure is a schematic diagram and is not necessarily an exact representation.

### Configuration of System 1

A system 1 in the present disclosure is an information processing system that provides an information processing service for efficiently managing inquiries from customers by telephone or the like.

The system 1 includes information processing apparatuses of a server 10, a first user terminal 20, a second user terminal 30, a voice server (PBX) 50, and a CRM system 60, which are connected via a network N.

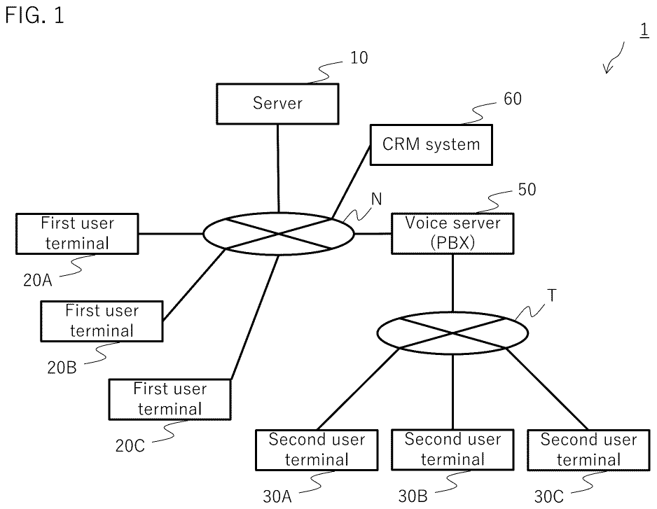

FIG. 1 is a block diagram showing a functional configuration of the system 1.

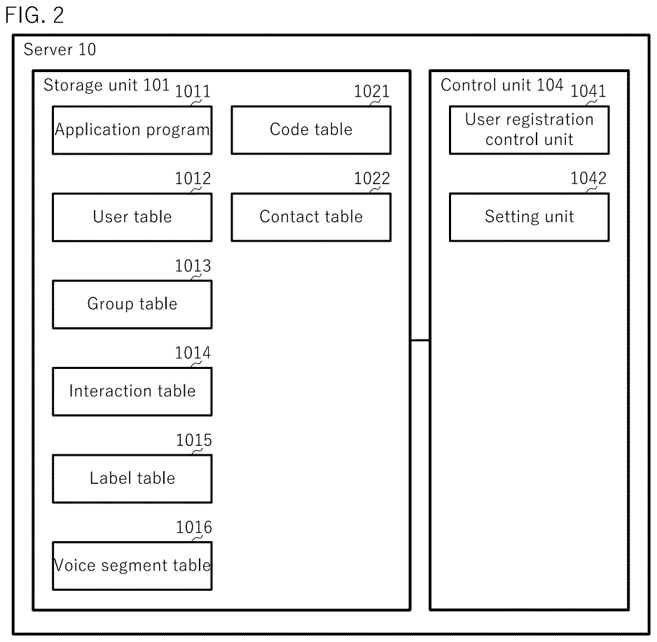

FIG. 2 is a block diagram showing a functional configuration of the server 10.

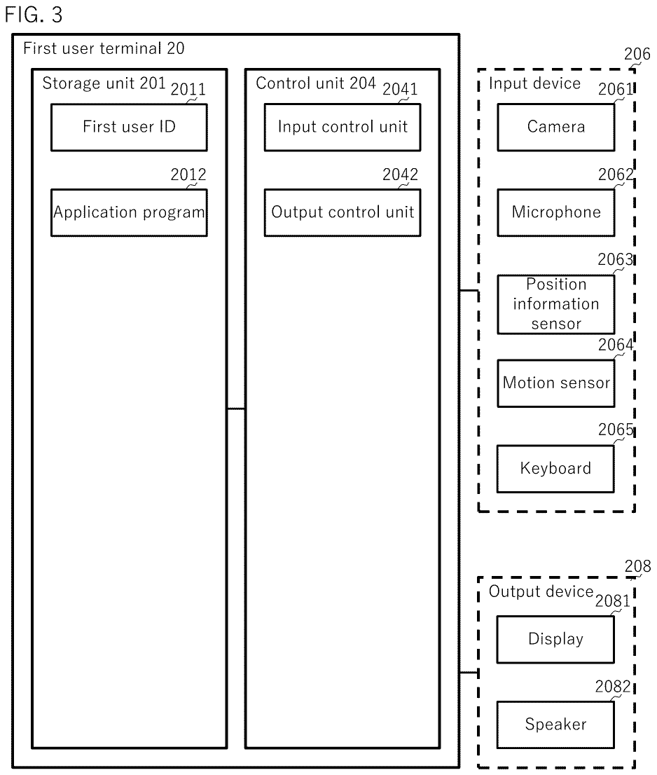

FIG. 3 is a block diagram showing a functional configuration of the first user terminal 20.

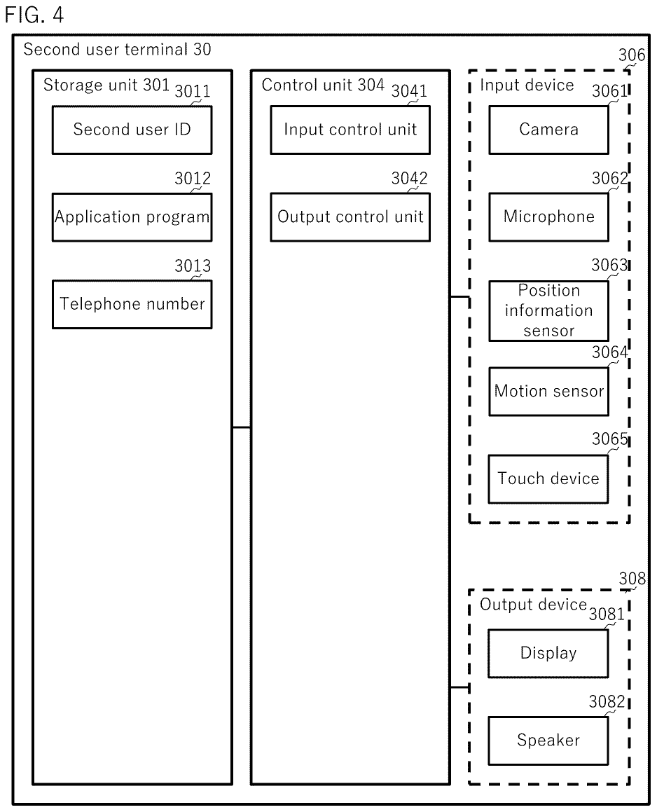

FIG. 4 is a block diagram showing a functional configuration of the second user terminal 30.

Each information processing apparatus is constituted by a computer including an arithmetic apparatus and a storage apparatus. A basic hardware configuration of the computer and a basic functional configuration of the computer realized by the hardware configuration will be described later. For each of the server 10, the first user terminal 20, the second user terminal 30, the voice server (PBX) 50, and the CRM system 60, descriptions redundant with the descriptions of the basic hardware configuration of the computer and the basic functional configuration of the computer to be provided later will be omitted.

### Configuration of Server 10

The server 10 is an information processing apparatus that provides an information processing service for executing predetermined information processing in response to an inquiry from a customer by telephone or the like.

The server 10 according to the present disclosure is an information processing apparatus that provides an interaction service (online interaction service) performed online between a first user who is an operator and a second user who is a customer. It should be noted that the server 10 according to the present disclosure may also be capable of providing an interaction service performed online among three or more users including a plurality of operators and a plurality of customers.

It should be noted that the customer is not necessarily a user of the information processing service according to the present disclosure.

The server 10 includes a storage unit 101 and a control unit 104.

### Configuration of Storage Unit 101 of Server 10

The storage unit 101 of the server 10 includes an application program 1011, a user table 1012, a group table 1013, an interaction table 1014, a label table 1015, a voice segment table 1016, a code table 1021, and a contact table 1022.

The application program 1011 is a program for causing the control unit 104 of the server 10 to function as each functional unit.

The application program 1011 includes an application such as a web browser application.

The user table 1012 is a table for storing and managing information on users. When a user registers to use the service, information of the user is stored in a new record in the user table 1012. This enables the user to use the service according to the present disclosure. In the present disclosure, the user table 1012 is a table having columns of user ID, group ID, user name, and user attribute with the user ID as the primary key.

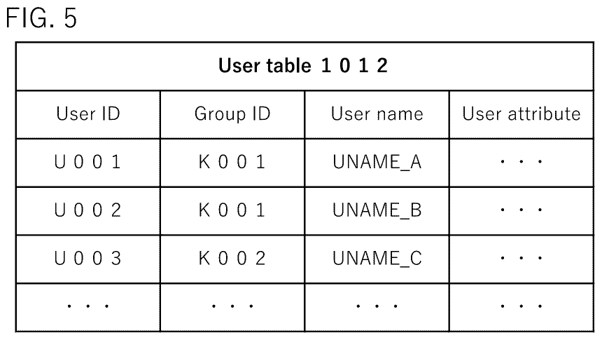

FIG. 5 Shows a Data Structure of the User Table 1012.

The user ID is an item for storing user identification information for identifying the user. The user identification information is an item of a unique value set for each user.

The group ID is an item for storing group identification information for identifying the group. Storing one or more pieces of group identification information in association with each user indicates that the user belongs to one or more groups.

The user name is an item for storing the name of the user. The user name may be any character string such as a nickname, rather than a full name.

The user attribute is an item for storing attribute information on the user.

Specifically, the user attribute includes a user's name, age, date of birth, contact information (telephone number, email address, chat ID, etc.), address, sex, registration date, and last login date and time.

In addition, the user attribute may include a group attribute of a group to which the user belongs.

The user attribute may also include customer information of the user. For example, the customer information may include information such as a user's transaction history (purchased products, service types, quantities, and prices), payment method (credit card, bank transfer, etc.), return and complaint history, service usage history (frequency of use, time of use, etc.), preferred product category and brand, hobby and area of interest, website and app behavior, social media activity, occupation, education level, family composition, customer service interaction records, and feedback or survey responses.

The group table 1013 is a table for storing and managing information (group information) on groups to which users belong. The group includes companies, corporations, corporate groups, clubs, various organizations, and any other arbitrary group. The group may also be more specific subgroups, such as company departments (sales, general affairs, and customer support).

The group table 1013 is a table having columns of group ID, group name, and group attribute with the group ID as the primary key.

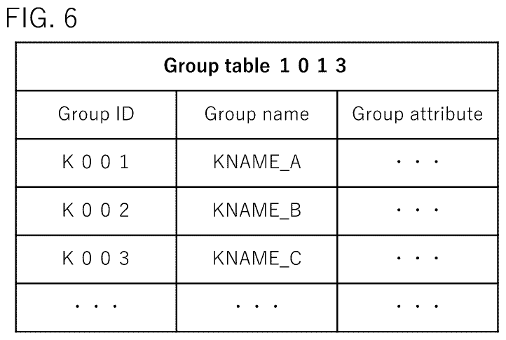

FIG. 6 shows a data structure of the group table 1013.

The group ID is an item for storing group identification information for identifying a group. The group identification information is an item of a unique value set for each piece of group information.

The group name is an item for storing the name of the group. The group name can be any character string.

The group attribute is an item for storing information on a group attribute such as a group type (company, corporate group, other organization, etc.) and a business type (real estate, finance, etc.).

The interaction table 1014 is a table for storing and managing information (interaction information) on interactions performed between users and customers.

The interaction table 1014 is a table having columns of interaction ID, user ID, customer ID, interaction category, incoming/outgoing call type, voice data, video data, and inquiry data with the interaction ID as the primary key.

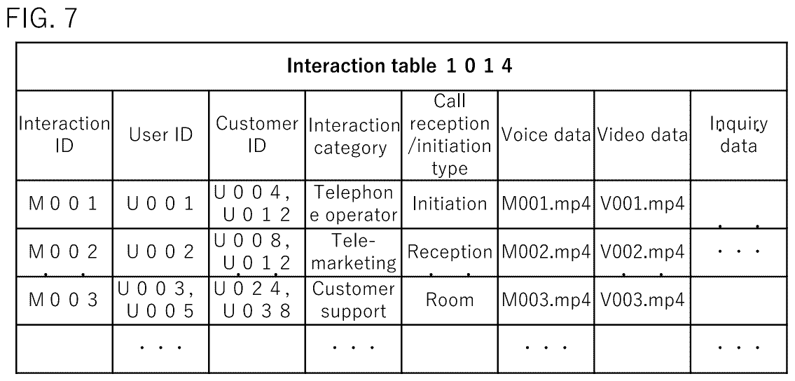

FIG. 7 shows a data structure of the interaction table 1014.

The interaction ID is an item for storing interaction identification information for identifying an interaction. The interaction identification information is an item of a unique value set for each piece of interaction information.

The user ID is an item for storing user identification information for identifying the user in the interaction performed between the user and the customer. A plurality of user IDs may be associated with each piece of interaction information.

The customer ID is an item for storing user identification information for identifying the customer in the interaction performed between the user and the customer. The user IDs of a plurality of customers may be associated with each piece of interaction information.

The interaction category is an item for storing the type (category) of the interaction performed between the user and the customer. The interaction data is classified by interaction category. In the interaction category, values of the telephone user, telemarketing, customer support, technical support, and the like are stored in accordance with the purpose of the interaction between the user and the customer.

The call reception/initiation type is an item for storing information for distinguishing whether the interaction performed between the user and the customer is initiated by the user (outbound) or received by the user (inbound). In addition, in the case of an interaction among three or more users, the call reception/initiation type “room” is stored.

The voice data is an item for storing voice data collected by a microphone. Reference information (path) to a voice data file located at another location may be stored. The format of the voice data may be any data format such as AAC, ATRAC, mp3, or mp4.

The voice data may be data in a format in which identifiers that can independently identify the voice of the user and the voice of the customer are set. In this case, the control unit 104 of the server 10 can perform independent analysis processing for each of the voice of the user and the voice of the customer. In addition, the user ID and the customer ID can be identified based on the voice data of the user and the voice data of the customer.

In the present disclosure, video data including voice information may be used in place of voice data. In addition, the voice data in the present disclosure includes voice data included in video data.

The video data is an item for storing video data captured by a camera or the like. Reference information (path) to a video data file located at another location may be stored. The format of the video data may be any data format such as MP4, MOV, WMV, AVI, or AVCHD.

The video data may be data in a format in which identifiers that can independently identify the video of the user and the video of the customer are set. In this case, the control unit 104 of the server 10 can perform independent analysis processing for each of the video of the user and the video of the customer. In addition, the user ID and the customer ID can be identified based on the video data of the user and the video data of the customer.

The inquiry data is an item for storing information on a customer in an interaction with the customer.

Specifically, the inquiry data includes the user attribute of the customer, first user data stored in the first user terminal of the customer, input information (generated information) input by the customer through an input operation or the like at the first user terminal, and additional data embedded in the two-dimensional code read by the customer at the first user terminal.

The label table 1015 is a table for storing and managing information (label information) on labels.

The label table 1015 includes columns of interaction ID and label data.

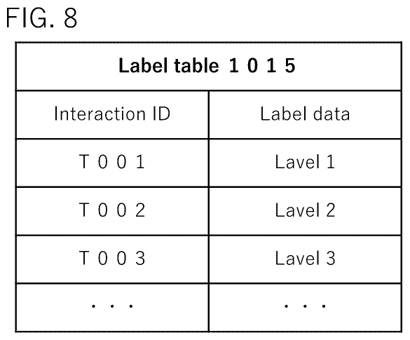

FIG. 8 shows a data structure of the label table 1015.

The interaction ID is an item for storing interaction identification information for identifying an interaction.

The label data is an item for storing label information for managing the interaction.

The label information is additional information for managing interaction information, such as a classification name, a label, a classification label, or a tag.

The label data may be a character string indicating the name of the label information, a label ID for referring to the name of the label information stored in another table, or the like. The label data includes classification information according to the emotional state of the speaker in a specific interaction. The classification data includes classification information for classifying whether the response of the speaker in a specific interaction is good or bad.

The voice segment table 1016 is a table for storing and managing information (voice segment information) on a plurality of voice segments included in interaction information.

The voice segment table 1016 is a table having columns of segment ID, interaction ID, speaker ID, start date and time, end date and time, segment voice data, segment video data, and segment reading aloud text, with the segment ID as the primary key.

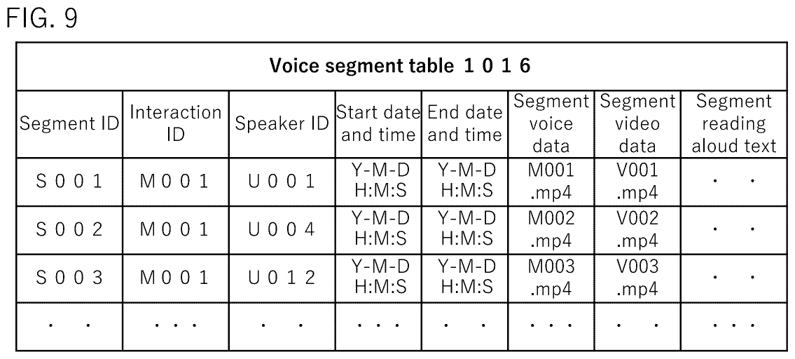

FIG. 9 shows a data structure of the voice segment table 1016.

The segment ID is an item for storing segment identification information for identifying a voice segment. The segment identification information is an item of a unique value set for each piece of voice segment information.

The interaction ID is an item for storing interaction identification information for identifying the interaction associated with the voice segment information.

The speaker ID is an item for storing speaker identification information for identifying the speaker associated with the voice segment information. Specifically, the speaker ID is an item for storing a plurality of user IDs and customer IDs participating in the interaction.

The start date and time is an item for storing the start date and time of the voice segment and the video segment.

The end date and time is an item for storing the end date and time of the voice segment and the video segment.

The segment voice data is an item for storing voice data included in the voice segment. Alternatively, reference information (path) to a voice data file located at another location may be stored. It is also possible to store a reference to the voice data from the start date and time to the end date and time of the voice data in the interaction table 1014, based on the start date and time and the end date and time. In addition, the segment voice data may include voice data included in the segment video data.

The format of the voice data may be any data format such as AAC, ATRAC, mp3, or mp4.

The segment video data is an item for storing video data included in the voice segment. Alternatively, reference information (path) to a video data file located at another location may be stored. It is also possible to store a reference to the video data from the start date and time to the end date and time of the video data of the interaction table 1014, based on the start date and time and the end date and time.

The format of the video data may be any data format such as MP4, MOV, WMV, AVI, or AVCHD.

The segment reading aloud text is an item for storing text information of the content spoken by the speaker in the segment voice data included in the voice segment. Specifically, the segment reading aloud text may be generated, based on the segment voice data or the segment video data, manually or using any learning model such as machine learning or deep learning.

The code table 1021 is a table for storing and managing information (code information) on codes.

In the present disclosure, a two-dimensional code will be particularly described as an example of the code.

The code table 1021 is a table having columns of code ID, code image data, URL, and additional data with the code ID as the primary key.

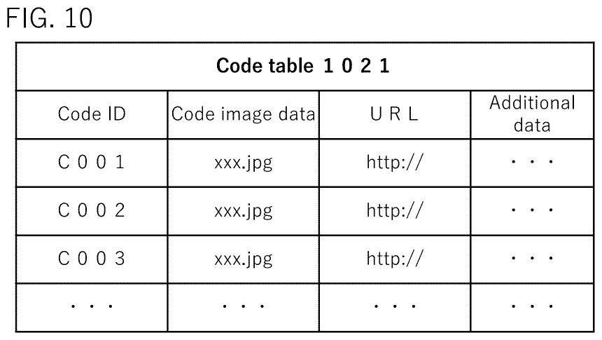

FIG. 10 shows a data structure of the code table 1021. It should be noted that the code image data included in the code table 1021

The code ID is an item for storing code identification information for identifying a code. The code identification information is an item of a unique value set for each piece of code information.

The code image data is an item for storing a two-dimensional code generated based on character strings of a URL and additional data. The two-dimensional code includes a barcode, a QR code (registered trademark), and the like. In the present disclosure, a QR code (registered trademark) is described as an example of the two-dimensional code, but the two-dimensional code is not limited thereto.

The URL and the additional data are embedded in the QR code (registered trademark) by a known encoding method. Various methods for generating the QR code (registered trademark) are known and will not be described in the present disclosure.

The format of the coded image data may be any data format such as jpeg, png, bmp, tiff, gif, eps, svg, or the like.

The URL is an item for storing a URL character string (abbreviated as URL).

The URL may include a link or the like to a shortened URL for transferring a received URL to another predetermined URL.

The additional data is an item for storing additional information to be embedded in the two-dimensional code.

Specifically, the additional data includes information for identifying a place or a medium to which the two-dimensional code is attached, a period during which the two-dimensional code can be used, and the like. It should be noted that the code image data can be downloaded from the server 10 as appropriate. The downloaded code image data can be used by being attached to a predetermined place.

For example, when the two-dimensional code is attached to a hotel room or the like, the additional data includes a character string indicating the room number of the hotel room. For example, when the two-dimensional code is attached to a magazine, an advertisement or the like, the additional data includes a character string indicating the magazine, the advertisement, or the like. Thus, for example, the disclosure according to the present disclosure can be utilized for measuring responses to an advertisement or the like.

For example, when the two-dimensional code is attached to a product or the like, the additional data includes a manufacturing date, a model number, and a serial number of the product or the like. Further, the error code output from the product or the like may include a two-dimensional code. In this case, the additional data may include an error code for identifying the error.

In addition, the additional data may include the date and time when the two-dimensional code was generated (generation date and time).

The contact table 1022 is a table for storing and managing information (contact information) on contacts. It should be noted that the contact information table 1022 may include call initiation information such as the number of the call initiation source for initiating a call via a URL associated with the two-dimensional code.

The contact table 1022 is a table having columns of URL, contact data, and unique data.

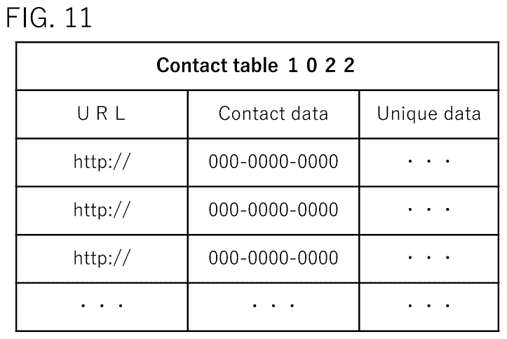

FIG. 11 shows a data structure of the contact table 1022.

The URL is an item for storing a URL character string (abbreviated as URL).

The contact data is an item for storing a contact stored in association with a URL. In the present disclosure, an example in which a telephone number is stored will be described as an example. Specifically, as the contact data, a telephone number of a call center or the like is stored. In the present disclosure, the two-dimensional code of the code table 1021 and the contact data are stored in association with each other using the URL as a key.

The unique data is an item for storing unique information on the contact.

The unique data includes information for, when a website associated with a URL is opened using a user terminal, generating contents of a web page to be displayed on the user terminal.

Specifically, the unique data includes information on an affiliated organization, a company, a business type, a call center type, and a name of the contact. The unique data may include call center hours of operation, non-business days, languages in which services are provided, information on products and services, FAQs, campaign and promotion information, operator specialties, waiting time and reservation information, links to online manuals and tutorials, etc.

### Configuration of Control Unit 104 of Server 10

The control unit 104 of the server 10 includes a user registration control unit 1041. The control unit 104 implements each functional unit by executing the application program 1011 stored in the storage unit 101.

The user registration control unit 1041 performs a process of storing information on the user who desires to use the service according to the present disclosure in the user table 1012.

The information stored in the user table 1012 is transmitted to the server 10 by the user opening a web page or the like operated by a service provider and inputting information in a predetermined input form through any information processing terminal. The user registration control unit 1041 stores the received information in a new record of the user table 1012, completing the user registration. Thus, the user stored in the user table 1012 can use the service.

Prior to the registration of the user information in the user table 1012 by the user registration control unit 1041, the service provider may conduct a predetermined review and restrict the user's ability to use the service.

The user ID may be any character string or numeral capable of identifying the user, and may be any character string or numeral desired by the user or any character string or numeral automatically set by the user registration control unit 1041.

### Configuration of First User Terminal 20

The first user terminal 20 is an information processing apparatus operated by the user who uses the service. The first user terminal 20 may be, for example, a stationary personal computer (PC) or a laptop PC, or a portable terminal such as a smartphone or a tablet. Further, it may be a head mount display (HMD), or a wearable terminal such as a wristwatch type terminal.

The first user terminal 20 includes a storage unit 201, a control unit 204, an input apparatus 206, and an output apparatus 208.

### Configuration of Storage Unit 201 of First User Terminal 20

The storage unit 201 of the first user terminal 20 includes a first user ID 2011, an application program 2012, and first user data 2021.

As the first user ID 2011, user identification information of the operator is stored. The operator transmits the first user ID 2011 from the first user terminal 20 to the voice server (PBX) 60. The voice server (PBX) 60 identifies the operator based on the first user ID 2011, and provides the service according to the present disclosure to the operator. It should be noted that the first user ID 2011 includes information on a session ID or the like temporarily assigned by the voice server (PBX) 60 for identifying the operator using the first user terminal 20.

The application program 2012 may be stored in the storage unit 201 in advance, or may be downloaded, via a communication IF, from a web server or the like operated by the service provider.

The application program 2012 includes applications, such as a web browser application.

The application program 2012 includes an interpreted programming language such as JavaScript (registered trademark) executed on a web browser application stored in the first user terminal 20.

The first user data 2021 stores information on the first user.

Specifically, the first user data 2021 may include the name, age, date of birth, contact information (telephone number, email address, chat ID, etc.), address, sex, registration date, and last login date and time of the first user. The first user data 2021 may include position information and coordinate information acquired by a position information sensor 2063 (GPS or the like) of the first user terminal. The first user data 2021 may include personal information such as a membership number and an insurance card number.

In addition, the first user data 2021 may include information on the first user, such as a first user's transaction history (purchased products, service types, quantities, and prices), payment method (credit card, bank transfer, etc.), return and complaint history, service usage history (frequency of use, time of use, etc.), preferred product category and brand, hobby and area of interest, website and app behavior, social media activity, occupation, education level, family composition, customer service interaction records, and feedback or survey responses.

### Configuration of Control Unit 204 of First User Terminal 20

The control unit 204 of the first user terminal 20 includes an input control unit 2041 and an output control unit 2042. The control unit 204 implements each functional unit by executing the application program 2012 stored in the storage unit 201.

### Configuration of Input Apparatus 206 of First User Terminal 20

The input apparatus 206 of the first user terminal 20 includes a camera 2061, a microphone 2062, a position information sensor 2063, a motion sensor 2064, and a keyboard 2065.

### Configuration of Output Apparatus 208 of First User Terminal 20

The output apparatus 208 of the first user terminal 20 includes a display 2081 and a speaker 2082.

### Configuration of Second User Terminal 30

The second user terminal 30 is an information processing apparatus operated by the customer who uses the service. The second user terminal 30 may be, for example, a portable terminal such as a smartphone or a tablet, or may be a stationary personal computer (PC) or a laptop PC. Further, it may be a head mount display (HMD), or a wearable terminal such as a wristwatch type terminal.

The second user terminal 30 includes a storage unit 301, a control unit 304, an input apparatus 306, and an output apparatus 308.

### Configuration of Storage Unit 301 of Second User Terminal 30

The storage unit 301 of the second user terminal 30 includes an application program 3012 and a telephone number 3013.

The application program 3012 may be stored in the storage unit 301 in advance, or may be downloaded, via a communication IF, from a web server or the like operated by the service provider.

The application program 3012 includes applications, such as a web browser application.

The application program 3012 includes an interpreted programming language such as JavaScript (registered trademark) executed on a web browser application stored in the second user terminal 30.

### Configuration of Control Unit 304 of Second User Terminal 30

The control unit 304 of the second user terminal 30 includes an input control unit 3041 and an output control unit 3042. The control unit 304 implements each functional unit by executing the application program 3012 stored in the storage unit 301.

### Configuration of Input Apparatus 306 of Second User Terminal 30

The input apparatus 306 of the second user terminal 30 includes a camera 3061, a microphone 3062, a position information sensor 3063, a motion sensor 3064, and a touch apparatus 3065.

### Configuration of Output Apparatus 308 of Second User Terminal 30

The output apparatus 308 of the second user terminal 30 includes a display 3081 and a speaker 3082.

### Configuration of Voice Server (PBX) 50

The voice server (PBX) 50 is an information processing apparatus that connects the network N and a telephone network T to each other to function as a switchboard that enables interactions between the first user terminal 20 and the second user terminal 30.

The voice server (PBX) 50 includes a storage unit 501.

### Configuration of Storage Unit 501 of Voice Server (PBX) 50

The storage unit 501 of the voice server (PBX) 50 includes an application program 5011.

The application program 5011 is a program for causing the control unit 504 of the voice server (PBX) 50 to function as each functional unit.

The application program 5011 includes applications, such as a web browser application.

### Configuration of CRM System 60

The CRM system 60 is an information processing apparatus operated by a provider different from the interaction service provider according to the present disclosure. The CRM system 60 is an information processing apparatus that provides an information processing service or the like operated by the provider.

The CRM system 60 may be an information processing apparatus managed and operated by a provider (CRM provider) that provides a customer relationship management (CRM) service. The CRM service includes SalesForce, HubSpot, Zoho CRM, and kintone.

The CRM system 60 may be an information processing apparatus managed and operated by a provider that provides a chat service. The chat service includes Slack, Chatwork, and LINE Works.

### Operation of System 1

Hereinafter, each process of the system 1 will be described.

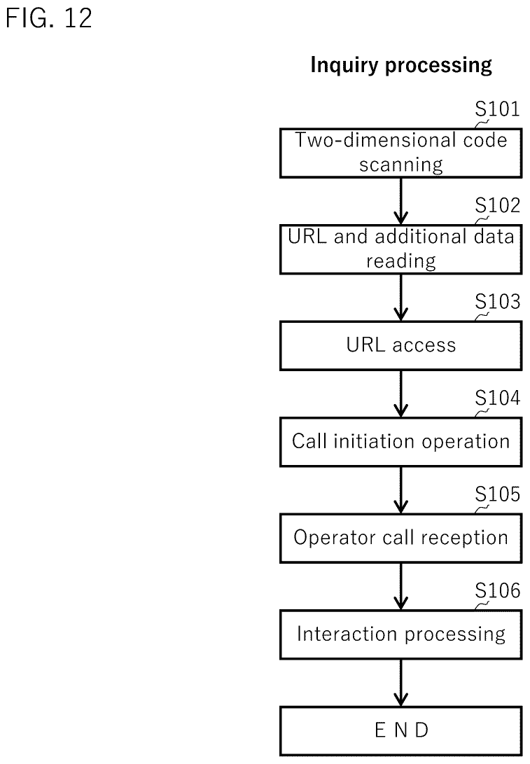

FIG. 12 is a flowchart showing an operation of inquiry processing.

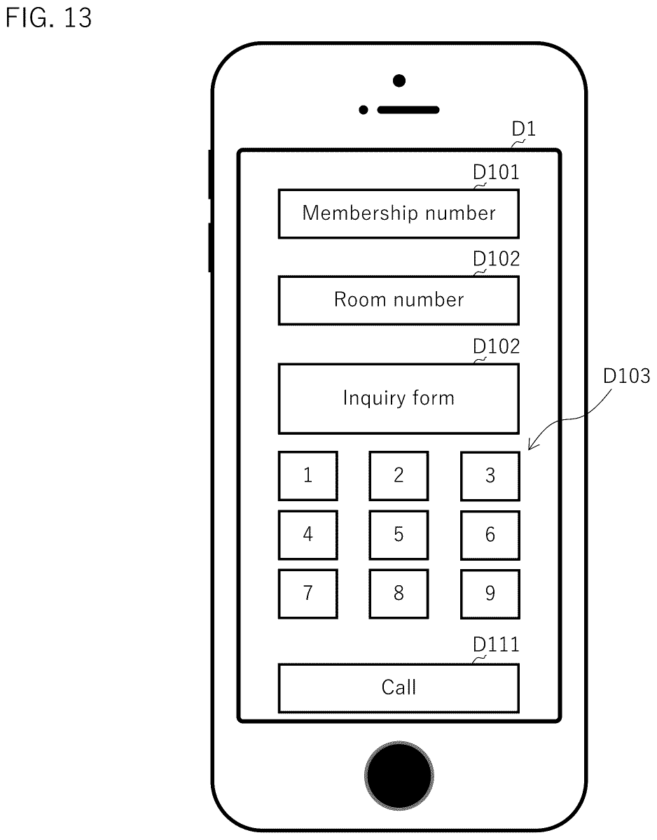

FIG. 13 is a screen example showing an operation of a call initiation page in the inquiry processing.

### Inquiry Processing

The inquiry processing is processing for a first user and the second user to enter a state in which the first user and a second user can interact with each other by the first user operating the first user terminal to read a predetermined two-dimensional code, initiating a call to (calling) the second user based on the two-dimensional code, and the second user receiving (answering) the call.

### Outline of Inquiry Processing

The inquiry processing is a series of processes in which a two-dimensional code is scanned by the first user (customer) operating the first user terminal, a URL and additional data embedded in the two-dimensional code are read, the first user terminal accesses the URL, a call is initiated (made) via the URL to the second user terminal of the second user (operator), the first user terminal transmits additional information that does not include voice information related to the call to the second user terminal, the second user terminal receives the additional information, the second user terminal receives the call from the first user, and the second user interacts with the first user while confirming the additional information received from the first user terminal.

In the present disclosure, the additional information includes at least one of or a combination of at least one of embedded information embedded in the two-dimensional code and not related to the first user, input information (generated information) input by an input operation or the like on the first user terminal, and first user data stored in the first user terminal.

### Details of Inquiry Processing

Details of the inquiry processing will be described below.

### Two-Dimensional Code Scanning

In step S101, the control unit 204 of the first user terminal 20 reads the two-dimensional code with a code reader.

Specifically, the first user operates the input apparatus 206 of the first user terminal 20 to execute the application program 2012 for reading the two-dimensional code stored in the first user terminal. The first user operates the input apparatus 206 of the first user terminal 20 to control the camera 2061 of the first user terminal 20, which is an example of the code reader, to read the two-dimensional code attached or displayed in the environment where the first user is in.

It should be noted that it is not always necessary to use the camera 2061 to read the two-dimensional code, and any means capable of reading the two-dimensional code, such as a bar code scanner, can be used. An internal antenna (not shown) provided in the first user terminal 20 may be used to read information corresponding to the two-dimensional code by wireless communication based on generated magnetic field.

For example, in the present disclosure, a case of reading a two-dimensional code attached to a hotel room will be described as an example.

### Two-Dimensional Code Reading

In step S102, the control unit 204 of the first user terminal 20 executes a URL identifying step of reading the two-dimensional code with the code reader and identifying a predetermined URL based on the two-dimensional code. The URL identifying step includes a step of acquiring embedded information not related to the first user, which is embedded in the two-dimensional code, based on the two-dimensional code.

Specifically, the control unit 204 of the first user terminal 20 analyzes the image of the read two-dimensional code, and outputs a character string. For example, a 13-digit or 8-digit number is identified in the case of a bar code, and 7089-character or 4296-character number is identified in the case of a QR code (registered trademark). In the present disclosure, the character string identified by the two-dimensional code includes character strings related to the URL and the embedded information.

For example, the control unit 204 of the first user terminal 20 may be configured to identify a character string related to an HTTP request URL including a URL and a parameter (GET query) transmitted by being appended to the URL as embedded information.

Below, an example configuration for transmitting embedded information related to character string data will be described, but the embedded information does not necessarily have to be character string data, and may include data in any format, such as binary data or image data.

### URL Access

In step S103, the control unit 204 of the first user terminal 20 opens the URL identified in step S102 by executing a browser application or the like.

By opening the identified URL with the browser application, the control unit 204 of the first user terminal 20 causes the display 2081 of the first user terminal 20 to display a predetermined web page (call initiation page) to presents it to the first user.

Upon receiving the access from the first user terminal 20, the server 10 searches the items of URL in the contact table 1022 based on the URL, acquires contact data and unique data, generates a call initiation page D1 based on the contact data and the unique data, and transmits the call initiation page D1 to the first user terminal 20.

FIG. 13 is a screen example of the call initiation page in the inquiry processing. The call initiation page D1 is displayed on the display 2081 of the first user terminal 20. The call initiation page D1 includes input fields D101, D102, . . . of an input form, an input button D103, and a call button D111.

Step S103 includes a transmission step of transmitting additional information including the embedded information identified in the URL identifying step to the predetermined URL.

Specifically, the URL opened by the browser application may include embedded information related to the GET query identified in step S102. Thus, the character string associated with the embedded information identified by the GET request is transmitted to the URL identified in step S102.

It should be noted that the browser application may be configured to transmit character string data or the like associated with the embedded information to the identified URL using an HTTP request (POST request or the like).

In step S103, the control unit 204 of the first user terminal 20 executes a transmitting step of transmitting, to the predetermined URL identified in the URL identifying step, additional information that does not include the voice information related to the call of the first user of the first user terminal. The transmitting step includes a step of transmitting, to the predetermined URL, additional information that includes first user information of the first user stored in the storage unit and generated information generated based on an operation of the first user at the first user terminal.

Specifically, the control unit 204 of the first user terminal 20 may transmit, to the identified URL, character string data or the like that includes the first user data 2021 stored in the storage unit 201 of the first user terminal 20 by including it in an HTTP request (POST request or the like).

Further, a configuration may be adopted in which generated information generated based on an operation by the first user at the first user terminal 20, such as input information input by the first user operating the input apparatus 206 of the first user terminal 20 or image data acquired by the first user operating the camera 2061 of the first user terminal 20, is transmitted to the identified URL.

For example, a configuration may be adopted in which the first user inputs information such as a character string into input fields D101, D102, . . . provided on the call initiation page D1 by operating the input apparatus 206 of the first user terminal 20, and the information such as the character string is transmitted to the identified URL. In addition, a configuration may be adopted in which the input information such as the character string is transmitted to a destination other than the server 10 instead of the identified URL.

It should be noted that the input form included in the call initiation page D1 may include an input button D103 capable of inputting a number or a keyboard. A configuration may be adopted in which the first user operates the input apparatus 206 of the first user terminal 20 to press the input button D103 of a numeral, a keyboard, or the like included in the input form, so that the value of the pressed numeral, the keyboard, or the like is transmitted.

For example, the first user may input a membership number, an insurance card number, information indicating a location such as a room number of a hotel in which a two-dimensional code is installed, a desired language for an operator, and information on a desired response method such as which of an automatic response (IVR) and a response by an operator is desired into the input form by operating the input apparatus 206 of the first user terminal 20.

The transmitting step may be executed in response to the call initiating step.

Specifically, a configuration may be adopted in which the control unit 204 of the first user terminal 20 transmits the additional information of the first user to the identified URL after the call initiation operation in step S104 to be described later. That is, the control unit 204 of the first user terminal 20 does not have to transmit the embedded information and the additional information excluding the embedded information to the identified URL at the same time, but may transmit them at different timings. Similarly, the control unit 204 of the first user terminal 20 may transmit the embedded information, the first user information, and the generated information at different timings.

For example, the control unit 204 of the first user terminal 20 may transmit at least one of the embedded information, the first user information, and the generated information during a call between the first user and the second user after the interaction processing in step S106. Further, the transmission need not be performed only once, but may be performed a plurality of times. For example, the first user may operate the input apparatus 206 of the first user terminal 20 to press a number, a keyboard, or the like included in the input form, thereby transmitting the value of the pressed number, keyboard, or the like during the call.

The control unit 204 of the first user terminal 20 may execute an agreeing step of requesting the first user to agree to transmit the additional information before the transmitting step. The transmitting step may be executed in response to the reception of an operation indicating agreement from the first user in the agreeing step. In response to the reception of an operation indicating disagreement from the first user in the agreeing step, the transmitting step may be executed without executing the transmitting step.

Specifically, the control unit 204 of the first user terminal 20 may be configured to, when transmitting the additional information of the first user to the identified URL, cause the display 2081 of the first user terminal 20 to display an interaction or the like for confirming whether the additional information may be transmitted, transmit the additional information only when agreement (consent) to transmit the additional information to the identified URL is acquired from the first user in the interaction, and refrain from transmitting the additional information when the agreement is not acquired from the first user.

This is because the additional information includes the first user data 2021 of the first user, which is stored in the storage unit 201 of the first user terminal 20, and the first user may not want to transmit the first user data 2021 to an external URL.

The transmitting step includes a step of transmitting generated information without transmitting the first user information, in response to the reception of the operation indicating disagreement from the first user in the agreeing step.

Specifically, a configuration may be adopted in which the control unit 204 of the first user terminal 20 transmits generated information generated based on the operation of the first user at the first user terminal 20 to the identified URL regardless of the presence or absence of the agreement of the first user.

Thus, when the first user does not agree to transmit the additional information, it is possible to transmit only the input information (generated information) received through the input operation at the first user terminal and initiate a call without transmitting the first user information which is the unique information of the first user.

### Call Initiation Processing

In step S104, the control unit 204 of the first user terminal 20 executes a call initiating step of initiating a call to a predetermined call destination associated with the predetermined URL identified in the URL identifying step.

Specifically, the first user operates the input apparatus 206 of the first user terminal 20 to select the call initiation button D111 provided in the call initiation page D1. The control unit 204 of the first user terminal 20 executes control to initiate a call (make a call) to a predetermined call destination in response to pressing of the call initiation button D111 by the first user. The call destination is determined in accordance with the contact data included in the call initiation page D1. Specifically, the call destination is determined in accordance with the URL identified in step S102 and the embedded information.

The server 10 according to the present disclosure has a communication function that uses the web real time communication (WebRTC) method. The server 10 can perform communication (SIP communication) with the voice server (PBX) 50 using the session initiation protocol (SIP) method. The server 10 has a function as a gateway for converting communication protocols, and performs mutual conversion between the WebRTC method and the SIP method. That is, the server 10 converts WebRTC data received from the first user terminal (voice data collected by the microphone 2062 of the first user terminal 20) into SIP data (voice data) and transmits it to the voice server (PBX) 50. Further, the server 10 converts SIP data received from the voice server (PBX) 50 (voice data collected by the microphone 3062 of the second user terminal 30) into WebRTC data (voice data), and transmits it to the first user terminal 20 via the Internet. This enables telephone communication between the first user terminal 20 and the second user terminal 30.

It should be noted that the SIP data may be transmitted to the second user terminal 30 with the additional information including the embedded information, the first user information, and the generated information included therein. In addition, the first user terminal 20 may generate a unique character string such as a predetermined hash value, transmit the hash value together with the embedded information, the first user information, and the generated information to the identified URL, and transmit SIP data to the second user terminal 30 by including the hash value therein.

Upon receipt of a call from the first user terminal 20, the second user may search the additional information including the embedded information, the first user information, and the generated information received based on the hash value, thereby identifying the additional information including the embedded information, the first user information, and the generated information transmitted from the first user as the call target.

In addition, in the present disclosure, descriptions will be provided assuming the configuration in which the information transmitted to the URL identified in step S102 can be received by the server 10. The web site associated with the URL identified in step S102 may be provided by the server 10, or data may be transferred from the web site associated with the identified URL to the server 10.

In step S104, the transmitting step may include a step of transmitting, to a predetermined call destination, without receiving an operation on the first user terminal by the first user in response to the predetermined URL being identified in the URL identifying step.

Specifically, in the present disclosure, as an example, a mode in which a call is initiated to a predetermined call destination in response to pressing of the call initiation button D111 by the first user has been disclosed as an example, but the configuration is not limited thereto. For example, a configuration may be adopted in which, in response to access to the URL identified in step S103, control to initiate a call to a predetermined call destination is executed without the first user operating the input apparatus 206 of the first user terminal 20.

Thus, the first user can initiate a call to a predetermined call destination without performing an input operation (call initiation operation) on the first user terminal 20. The operation burden on the first user can be reduced.

Consequently, the first user terminal 20 controls the speaker 2082 or the like to emit a ringing tone indicating that the voice server (PBX) 50 is initiating a call (calling). The display 2081 of the first user terminal 20 also displays information indicating that the voice server (PBX) 50 is initiating a call (calling) to the customer. For example, the display 2081 of the first user terminal 20 may display a character string of “calling”. Alternatively, an advertisement or the like may be displayed on the display 2081 of the first user terminal 20. Specifically, the control unit 104 of the server 10 selects or generates an advertisement suitable for the first user based on the embedded information, the first user information, and the generated information received from the first user terminal 20, and transmits the advertisement to the first user terminal. The control unit 204 of the first user terminal 20 causes the display 2081 of the first user terminal 20 to display and present the received advertisement.

### Operator Call Reception Processing

In step S105, the control unit 304 of the second user terminal 30 executes a call receiving step of receiving a call from the first user terminal.

Specifically, the operator lifts a receiver (not shown) on the second user terminal 30 or presses a “receive” button or the like displayed at the time of receiving a call on the input apparatus 306 of the second user terminal 30, thereby enabling the second user terminal 30 to interact. Consequently, the voice server (PBX) 50 transmits information indicating that the second user terminal 30 has responded (hereinafter referred to as a “response event”) to the first user terminal 20 via the server 10, the CRM system 60, and the like.

As a result, the user and the customer are enabled to interact with each other using the first user terminal 20 and the second user terminal 30, respectively. Specifically, the voice of the user collected by the microphone 2062 of the first user terminal 20 is output from the speaker 3082 of the second user terminal 30. Similarly, the voice of the customer collected from the microphone 3062 of the second user terminal 30 is output from the speaker 2082 of the first user terminal 20.

Thus, the first user and the second user can interact with each other by voice. It should be noted that, in step S105, the target of receiving a call from the first user terminal may be an automatic response using a AI or the like, instead of the operator.

When the first user terminal 20 is enabled to interact, the display 2081 of the first user terminal 20 displays information indicating that the first user terminal 20 has received a response event and is interacting.

For example, the display 2081 of the first user terminal 20 may display a character string of “responding”.

In step S105, the control unit 104 of the server 10 executes a receiving step of receiving additional information transmitted from the first user terminal, which includes the generated information generated based on the operation by the first user in the first user terminal and the embedded information not related to the first user and not including the voice information related to the call of the first user of the first user terminal.

Specifically, the control unit 104 of the server 10 receives and accepts additional information including the embedded information, the first user information, and the generated information transmitted by the first user terminal 20. It should be noted that the additional information including the embedded information, the first user information, and the generated information transmitted from the first user terminal 20 may be received via the URL identified in step S102 or via SIP communication.

In step S105, the control unit 104 of the server 10 executes a storing step of storing the additional information received in the receiving step. The storing step includes a step of storing the first user information and the generated information received in the receiving step in association with attribute information of the first user stored in the storage unit.

Specifically, the control unit 104 of the server 10 searches the items of user ID of the user table 1012 based on the user ID or the like included in the first user information, and acquires the item of user attribute (first user attribute information). It should be noted that the control unit 104 of the server 10 may identify the item of user attribute based on the user ID, the membership number, or the insurance card number of the user, which is included in the first user information or the generated information.

The control unit 104 of the server 10 stores the additional information including the embedded information, the first user information, and the generated information transmitted by the first user terminal 20, and the first user attribute information in association with each other in the item of inquiry data in the interaction table 1014.

In step S105, in response to the call received from the first user terminal in the call receiving step, the control unit 104 of the server 10 executes a storing step of storing the additional information received in the receiving step in association with the attribute information of the first user stored in the storage unit.

Specifically, when a call is started between the first user and the second user, interaction processing to be described later is executed, and interaction information related to the interaction is stored in a new record of the interaction table 1014. The control unit 104 of the server 10 stores the additional information including the embedded information, the first user information, and the generated information transmitted by the first user terminal 20 in the item of inquiry data of the target record of the interaction information related to the interaction by associating each piece of the first user attribute information with interaction information. The control unit 104 of the server 10 may store the additional information including the embedded information, the first user information, and the generated information transmitted by the first user terminal 20 by associating each piece of the first user attribute information with interaction information, in response to a response to (reception of) a call from the first user.

In step S106, the control unit 304 of the second user terminal 30 executes a presenting step of presenting the additional information and the embedded information stored in the storing step to an operator different from the first user in association with the attribute information of the first user.

Specifically, the control unit 104 of the server 10 generates a response screen D2 based on the first user attribute information and the additional information including the embedded information, the first user information, and the generated information transmitted by the first user terminal 20, which are stored in the item of inquiry data of the target record related to the current interaction in the interaction table 1014, and transmits the response screen D2 to the second user terminal 30. The control unit 304 of the second user terminal 30 causes the display 3081 of the second user terminal 30 to display and present the response screen D2.

In step S106, the control unit 304 of the second user terminal 30 executes a presenting step of presenting the additional information stored in the storing step to the operator different from the first user in association with the attribute information.

Specifically, the control unit 104 of the server 10 generates a response screen D2 in which the first user attribute information and the additional information including the embedded information, the first user information, and the generated information transmitted by the first user terminal 20 are associated, and transmits the response screen D2 to the second user terminal 30. The control unit 304 of the second user terminal 30 causes the display 2081 of the second user terminal 30 to display the received response screen D2 to present it to the second user.

It should be noted that the response screen D2 may be generated by the control unit 304 of the second user terminal 30 based on the received first user attribute information and additional information including the embedded information, the first user information, and the generated information transmitted by the first user terminal 20, instead of being generated by the control unit 104 of the server 10.

### Interaction Storing Processing

When the call from the first user is received by the second user and a call is started between the first user and the second user, interaction storing processing is executed. The interaction storing processing is processing for storing data related to an interaction performed between the first user and the second user.

### Outline of Interaction Storing Processing

The interaction storing processing is a series of processes of, when an interaction starts between the first user and the second user, storing data related to the interaction in the interaction table 1014.

### Details of Interaction Storing Processing

When an interaction between the first user and the second user starts, the voice server (PBX) 50 records voice data related to the interaction performed between the first user and the second user, and transmits the voice data to the server 10. Upon receiving the voice data, the control unit 104 of the server 10 creates a new record in the interaction table 1014, and stores data related to the interaction performed between the first user and the second user. Specifically, the control unit 104 of the server 10 stores the first user ID, the second user ID, the interaction category, the call initiation/reception type, and the content of the voice data in a new record of the interaction table 1014.

In the call initiation processing or the call reception processing, the control unit 104 of the server 10 acquires the first user ID 2011 of the first user from the first user terminal 20, and stores it in the item of first user ID of the new record of the interaction table 1014. In the call initiation processing or call reception processing, the control unit 104 of the server 10 makes an inquiry to the CRM system 60 based on the telephone number. The CRM system 60 searching a user table (not shown) stored in the CRM system using a telephone number to acquire a second user ID, and transmits it to the server 10. The control unit 104 of the server 10 stores the acquired second user ID in the item of second user ID of the new record of the interaction table 1014.

The control unit 104 of the server 10 stores the value of the interaction category set in advance for each first user or second user in the item of interaction category of the new record of the interaction table 1014. It should be noted that the interaction category may be stored by the first user selecting and inputting a value for each interaction.

The control unit 104 of the server 10 identifies whether the interaction being performed is initiated by the first or initiated by the second user, and stores a value of either outbound (initiated by the first user) or inbound (initiated by the second user) in the item of call initiation/reception type of the new record of the interaction table 1014.

The control unit 104 of the server 10 stores the voice data received from the voice server (PBX) 50 in the item of voice data of the new record of the interaction table 1014. It should be noted that the voice data may be stored as a voice data file at another location, and reference information (path) for the voice data file may be stored after the interaction is completed. Further, the control unit 104 of the server 10 may be configured to store the voice data after the interaction is completed.

Also, in the video interaction service, the control unit 104 of the server 10 stores the video data received from the first user terminal 20 and the second user terminal 30 in the item of video data of a new record of the interaction table 1014. The video data may be stored as a video data file at another location, and reference information (path) for the video data file may be stored after the interaction is completed. Further, the control unit 104 of the server 10 may be configured to store the video data after the interaction is completed.

The control unit 104 of the server 10 executes a voice extracting step of extracting, from the voice data acquired in the voice acquiring step, a plurality of segment voice data for each speech segment.

Specifically, the control unit 104 of the server 10 acquires (receives) the interaction ID, the voice data, and the video data stored in the interaction table 1014. The control unit 104 of the server 10 detects segments (speech segments) in which uttered voice continuously exist from the acquired (received) voice data and video data, and extracts the voice data and the video data for each of the speech segments as segment voice data and segment video data, respectively. For example, segment voice data and segment video data may be extracted by dividing voice data and video data using silent segments in which no uttered voice exists. It is also possible to extract segment voice data and segment video data by dividing voice data and video data into linguistic units such as segments, sentences, or paragraphs with respect to the speech content included in the voice data and the video data. The segment voice data and the segment video data are associated with the first user ID of the speaker, the start date and time of the speech segment, and the end date and time of the speech segment for each speech segment. The control unit 104 of the server 10 performs text recognition on the speech content of the extracted segment voice data and segment video data, thereby converting the segment voice data and segment video data into reading aloud text which is characters (text) for transcription. It should be noted that the specific method of text recognition is not particularly limited. For example, the conversion may be performed by machine learning or deep learning using a signal processing technique or artificial intelligence (AI).

The control unit 104 of the server 10 stores the processing target interaction ID, the user ID of the speaker (first user ID 2011 or second user ID 3011), the start date and time, the end date and time, the segment voice data, the segment video data, and the segment reading aloud text in the items of interaction ID, speaker ID, start date and time, end date and time, segment voice data, segment video data, and segment reading aloud text of a new record of the voice segment table 1016.

The voice segment table 1016 stores, as continuous time-series data, a segment reading aloud text for each speech segment of voice data in association with the start date and time and the speaker. By confirming the segment reading aloud text stored in the voice segment table 1016, the first user can check the content of the interaction as text information without checking the content of the voice data.

It should be noted that, at the time of text recognition processing, it is also possible to exclude, from the text, meaningless information for grasping the interaction performed between the first user and the second user, such as a filler included in the text in advance, and store voice recognition information in the voice segment table 1016.

The control unit 104 of the server 10 may transmit, to an external server, interaction information and voice segment information including a segment ID of a speech segment, a segment reading aloud text, a URL, a name of a speaker, information on a group such as a name of a group to which the speaker belongs, evaluation information, and the like. It should be noted that, when the interaction information and the voice segment information are transmitted to the external server, the interaction information and the voice segment information may be transmitted after authentication permission is obtained from the external server using the external service ID of the first user stored in the user table 1012.

The control unit 504 of the external server stores the received interaction information and voice segment information including the interaction ID, segment ID, speaker information, segment reading aloud text, URL, and evaluation information in the items of interaction ID, segment ID, speaker data, segment reading aloud text, URL, and evaluation data of a shared table 5012. The control unit 504 of the external server stores service identification information such as a service ID for identifying the interaction information service according to the present disclosure, a service name, and the like in the item of service ID. The service ID is identified based on the information received from the server 10.

It should be noted that the external server is an information processing apparatus operated by a provider different from the interaction service provider according to the present disclosure. The external server is an information processing apparatus that provides an information processing service or the like operated by the provider.

The external server may be an information processing apparatus managed and operated by a provider (CRM provider) that provides a customer relationship management (CRM) service. The CRM service includes SalesForce, HubSpot, Zoho CRM, and kintone. The external server includes the CRM system 60.

### Interaction Processing

There is a method in which a virtual interaction space called a room for an interaction between the first user and the second user is created on the server 10, and the first user and the second user access the room via web browsers or application programs stored in the first user terminal 20 and the second user terminal 30 to be placed in the interactive state. In this case, the voice server (PBX) 50 is unnecessary.

Specifically, the second user operates the input apparatus 306 of the second user terminal 30 to transmit a request for initiating an interaction to the server 10. Upon receiving the request, the control unit 104 of the server 10 issues room identification information such as a unique room ID and transmits a response to the second user terminal 30. The room identification information is associated with the code ID, the URL, and the like of the code table 1021. It should be noted that the room identification information may be linked to the code ID, the URL, and the like of the code table 1021 and presented in a list to the second user, and the second user may select a desired room identification information from the room identification information presented in the list to enter the room.

The second user enters the room by operating the input apparatus 306 of the second user terminal 30, accessing the URL providing the room-related service of the server 10 using a web browser or the like, and inputting the room identification information. The second user waits until the first user enters the room. It should be noted that the second user may be notified when the first user enters the room, and the second user may enter the room in response to the notification.

Instead of initiating a call in step S104 of the inquiry processing, the first user may operate the input apparatus 206 of the first user terminal 20 to access the URL providing the room-related service of the server 10 using a web browser or the like in response to pressing of the call button D111. In this case, the information related to the room identification information may be embedded in the URL and the embedded information read in step S102, and the room identification information may be transmitted without any operation by the first user, so that the first user enters the room without inputting the room identification information.

The first user and the second user can thereby interact with each other via the first user terminal 20 and the second user terminal 30, respectively, in a virtual interaction space called a room associated with them by the room identification information.

By inputting the room identification information, in addition to the first user and the second user, one or more other users can enter one room. Thus, three or more users can interact with one another via their respective user terminals in a virtual interaction space called a room which is associated with them by the room identification information.

### Video Interaction Processing

The system 1 in the present disclosure may provide an online interaction service (video interaction service) including video data. For example, the control unit 204 of the first user terminal 20 and the control unit 304 of the second user terminal 30 transmit video data captured by the camera 2061 of the first user terminal 20 and video data captured by the camera 3061 of the second user terminal 30 to the server 10, respectively.

Based on the received video data, the server 10 transmits the video data captured by the camera 2061 of the first user terminal 20 to the second user terminal 30, and transmits the video data captured by the camera 3061 of the second user terminal 30 to the first user terminal 20. The control unit 204 of the first user terminal 20 causes the display 2081 to display the received video data captured by the camera 3061 of the second user terminal 30. The control unit 304 of the second user terminal 30 causes the display 3081 to display the received video data captured by the camera 2061 of the first user terminal 20.

The server 10 may transmit the video data of some or all of the users participating in the online interaction to the first user terminal 20 and the second user terminal 30. In this case, the control unit 204 of the first user terminal 20 causes the display 2081 of the first user terminal 20 to display the received video data of some or all of the users participating in the online interaction side-by-side on a single screen. In this way, it is possible to check the interaction statuses of a plurality of users participating in the online interaction. The same processing may be executed at the second user terminal 30.

### MODIFICATIONS

Further, in the present disclosure, with respect to the interaction between the first user and the second user, a telephone call, interaction processing, and video interaction processing have been described, but the interaction need not necessarily be performed by voice. For example, steps S104 to S106 of the inquiry processing may be real-time communication with text information by chat between the first user and the second user. Specifically, the embedded information, the first user information, the generated information, the additional information, and the like may be presented and shared with the second user during real-time communication of text information or the like by chat between the first user and the second user.

### Two-Dimensional Code Management Processing

The second user may be able to edit the code table 1021 and the contact table 1022 by operating the input apparatus 306 of the second user terminal 30.

The second user operates the input apparatus 306 of the second user terminal 30 to input the URL of the page for executing the two-dimensional code management processing (two-dimensional code management processing page) into the web browser, predetermined application, or the like, thereby opening the two-dimensional code management processing page. The control unit 304 of the second user terminal 30 transmits a request for opening the two-dimensional code management processing page to the server 10. Based on the received request, the control unit 104 of the server 10 generates a two-dimensional code management processing page and transmits it to the second user terminal 30. The control unit 304 of the second user terminal 30 causes the display 3081 of the second user terminal 30 to display the received two-dimensional code management processing page.

The two-dimensional code management page includes the following, for example:
A screen for editing what kind of URL and additional data are to be embedded (allocated) in the two-dimensional code in the code table 1021;
A window for editing whether to allocate the contact data and the unique data in the contact table 1022.
An expiration date of the two-dimensional code (expiration date of use, etc. may be designated); and
An inquiry screen or the like enabling the inquiry of past data between the first user and the second user in the inquiry processing.

It should be noted that, in the two-dimensional code management page, a button or the like for downloading a two-dimensional code held in the code table 1021 may be provided. By operating the button, the designated two-dimensional code can be downloaded and attached to a predetermined document or the like. Further, a screen may be provided on which information on a customer related to a received call based on the two-dimensional code and data such as a past call history can be referred to.

### Basic Hardware Configuration of Computer

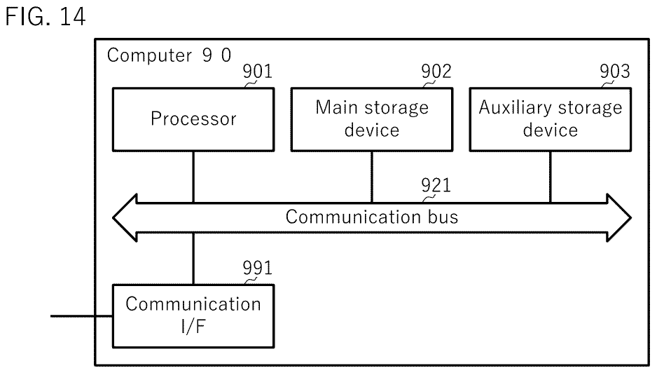

FIG. 14 is a block diagram showing a basic hardware configuration of a computer 90. The computer 90 includes at least a processor 901, a main storage apparatus 902, an auxiliary storage apparatus 903, and a communication interface (IF) 991. These are electrically connected to each other by a communication bus 921.

The processor 901 is hardware for executing an instruction set described in a program. The processor 901 is composed of an arithmetic unit, a register, a peripheral circuit, and the like.

The main storage apparatus 902 is used to temporarily store a program, data to be processed by the program, etc., and the like. For example, it is a volatile memory such as a dynamic random access memory (DRAM).

The auxiliary storage apparatus 903 is a storage apparatus for storing data and programs. For example, it is a flash memory, a hard disc drive (HDD), a magneto-optical disk, a CD-ROM, a DVD-ROM, a semiconductor memory, or the like.

The communication IF 991 is an interface for inputting and outputting signals to communicate with other computers through a network using a wired or wireless communication standard.

The network is composed of various mobile communication systems, etc. constructed by the Internet, a LAN, a wireless base station, etc. For example, the network includes a 3G, 4G, or 5G mobile communication system, long term evolution (LTE), a wireless network (such as Wi-Fi (registered trademark)) connectable to the Internet by a given access point, and the like. In the case of wireless connection, examples of the communication protocol include Z-Wave (registered trademark), ZigBee (registered trademark), and Bluetooth (registered trademark). In the case of wired connection, the network includes ones with direct connection by a universal serial bus (USB) cable or the like.

It should be noted that the computer 90 can be virtually realized by distributing all or part of each hardware configuration to a plurality of computers 90 and interconnecting them via a network. As described above, the computer 90 is a concept that includes not only the computer 90 housed in a single housing or case but also a virtualized computer system.

### Basic Functional Configuration of Computer 90

A functional configuration of the computer realized by the basic hardware configuration (FIG. 14) of the computer 90 will be described. The computer includes at least functional units of a control unit, a storage unit, and a communication unit.

The functional units of the computer 90 may be realized by distributing all or part of the functional units to a plurality of computers 90 connected to each other through a network. The computer 90 is a concept that includes not only a single computer 90 but also a virtualized computer system.

The control unit is realized by the processor 901 reading out various programs stored in the auxiliary storage apparatus 903, loading them into the main storage apparatus 902, and executing processing in accordance with the programs. The control unit can realize functional units that perform various types of information processing depending on the type of program. Thus, the computer is realized as an information processing apparatus that performs information processing.

The storage unit is realized by the main storage apparatus 902 and the auxiliary storage apparatus 903. The storage unit stores data, various programs, and various databases. In addition, the processor 901 can reserve a storage area corresponding to the storage unit in the main storage apparatus 902 or the auxiliary storage apparatus 903 in accordance with a program. In addition, the control unit can cause the processor 901 to execute processing for adding, updating, and deleting data stored in the storage unit in accordance with various programs.

The database refers to a relational database for managing a set of data, called a tabular table or master, structurally defined by rows and columns, in relation to each other. In the database, a table is called a table or a master, a table column is called a column, and a table row is called a record. In the relational database, relationships between tables or masters can be set so that they are associated with each other.

Normally, a column as the primary key for uniquely identifying the record is set in each table or each master, but it is not necessary to set the primary key for a column. The control unit can cause the processor 901 to execute addition, deletion, and update of a record in a specific table or master stored in the storage unit in accordance with various programs.

Further, the information processing apparatus and the information processing system according to the present disclosure can be understood as manufactured by storing data, various programs, and various databases in the storage unit.

It should be noted that the database or master in the present disclosure may include any data structure (list, dictionary, associative array, object, or the like) in which information is structurally defined. The data structure also includes data that can be regarded as a data structure by combining the data with a function, a class, a method, or the like described in any programming language.

The communication unit is realized by the communication IF 991. The communication unit realizes the function of communicating with another computer 90 through a network. The communication unit can receive information transmitted from another computer 90 and input the information to the control unit. The control unit can cause the processor 901 to execute information processing on the received information in accordance with various programs. Further, the communication unit can transmit information output from the control unit to another computer 90.

### APPENDIXES

The matters described in the above embodiments will be appended below.

### Appendix 1

A program for causing a first user terminal including a processor, a storage unit, and a code reader to process information on an interaction, wherein the processor executes: a URL identifying step (S102) of reading a two-dimensional code with the code reader and identifying a predetermined URL based on the two-dimensional code; a call initiating step (S104) of initiating a call to a predetermined call destination associated with the predetermined URL identified in the URL identifying step; and a transmitting step (S103) of transmitting additional information based on the predetermined URL identified in the URL identifying step, the additional information not including voice information related to a call of a first user of the first user terminal.

This allows the first user to initiate a call to a predetermined call destination identified based on a two-dimensional code and transmit additional information related to the call of the first user to the URL identified based on the two-dimensional code.

### Appendix 2

The program according to Appendix 1, wherein the URL identifying step (S102) includes a step of acquiring, based on the two-dimensional code, embedded information not related to the first user embedded in the two-dimensional code, and the transmitting step (S103) includes a step of transmitting the additional information based on the predetermined URL, the additional information including the embedded information identified in the URL identifying step.

This allows the first user to transmit, to the URL identified based on the two-dimensional code, embedded information or the like not related to the first user and embedded in the two-dimensional code together with additional information related to the call of the first user.

### Appendix 3

The program according to Appendix 1, wherein the transmitting step (S103) includes a step of transmitting the additional information based on the predetermined URL, the additional information including: first user information of the first user stored in the storage unit; and generated information generated based on an operation of the first user at the first user terminal.

This allows the first user to transmit, to the URL identified based on the two-dimensional code, first user information, which is unique information of the first user, stored in the first user terminal, and input information (generated information) received through an input operation at the first user terminal.

### Appendix 4

The program according to Appendix 1, wherein the transmitting step (S103) is executed in response to the call initiating step.

Accordingly, a call is initiated to a predetermined call destination in response to a call initiation operation by the first user, and additional information related to the call of the first user is transmitted to the URL identified based on the two-dimensional code.

### Appendix 5

The program according to Appendix 4, wherein the processor executes an agreeing step (S103) of requesting the first user to agree to transmit the additional information before the transmitting step, and executes the call initiating step without executing the transmitting step, in response to reception of an operation indicating disagreement from the first user in the agreeing step.

This makes it possible to request the first user for agreement before transmitting the additional information stored in the first user terminal to the URL identified based on the two-dimensional code.

### Appendix 6

The program according to claim 1, wherein the processor executes an agreeing step (S103) of requesting the first user to agree to transmit the additional information before the transmitting step, and executes the call initiating step without executing the transmitting step, in response to reception of an operation indicating disagreement from the first user in the agreeing step.

This allows the first user to initiate a call without transmitting the additional information stored in the first user terminal when the first user does not agree to transmit the additional information.

### Appendix 7

The program according to Appendix 3, wherein the processor executes an agreeing step (S103) of requesting the first user to agree to transmit the additional information before the transmitting step, and the transmitting step (S103) is a step of transmitting the generated information without transmitting the first user information, in response to reception of an operation indicating disagreement from the first user in the agreeing step.

Thus, when the first user does not agree to transmit the additional information, it is possible to transmit only the input information (generated information) received through the input operation at the first user terminal and initiate a call without transmitting the first user information which is the unique information of the first user.

### Appendix 8

The program according to Appendix 1, wherein the call initiating step (S104) is a step of initiating a call to the predetermined call destination without receiving an operation on the first user terminal by the first user, in response to the predetermined URL being identified in the URL identifying step.

Thus, the first user can initiate a call to a predetermined call destination without performing an input operation (call initiation operation) on the first user terminal. The operation burden on the first user can be reduced.

### Appendix 9

A program for causing a computer including a processor and a storage unit to process information on an interaction, wherein the processor executes: a call receiving step (S105) of receiving a call from the first user terminal; a receiving step (S105) of receiving additional information transmitted from the first user terminal, the additional information including embedded information not related to the first user and not including voice information related to the call of the first user of the first user terminal; and a storing step (S105) of storing the additional information received in the receiving step in association with attribute information of the first user stored in the storing unit, in response to the call being received from the first user terminal in the call receiving step.

This allows the additional information and embedded information received from the first user to be stored in association with the attribute information related to the first user stored in the server.

### Appendix 10

The program according to Appendix 9, wherein the receiving step (S105) includes: a step of receiving the additional information, the additional information including first user information of the first user stored in the storage unit, and generated information generated based on an operation of the first user at the first user terminal, and the storing step (S105) is a step of storing the first user information and the generated information received in the receiving step in association with the attribute information of the first user stored in the storage unit. This allows the first user information, which is the first user's personal unique information received from the first user, and the input information (generated information) received through an input operation on the first user terminal to be stored in association with attribute information related to the first user stored in the server.

### Appendix 11

The program according to Appendix 9, wherein the processor executes a presenting step (S106) of presenting the additional information stored in the storing step to an operator different from the first user in association with the attribute information of the first user.

This allows the operator to check all of the additional information related to the first user, the embedded information that is embedded in the two-dimensional code and is not related to the first user, and the attribute information related to the first user that is stored in the server.

### Appendix 12

A program for causing a system including a computer including a processor and a storage unit, and the first user terminal according to claim 1 to process information on an interaction, wherein the program executes: a call receiving step (S105) of receiving the call from the first user terminal; a receiving step (S105) of receiving additional information transmitted from the first user terminal, the additional information being related to the call of a first user of the first user terminal; and a storing step (S105) of storing the additional information received in the receiving step in association with attribute information of the first user of the first user terminal stored in the storing unit, in response to the call being received from the first user terminal in the call receiving step.

This allows the additional information received from the first user to be stored in association with the attribute information related to the first user stored in the server.

### Appendix 13

The program according to Appendix 12, wherein the processor executes a presenting step (S106) of presenting the additional information stored in the storing step to an operator different from the first user in association with the attribute information.

This allows the operator to check the additional information related to the first user together with the attribute information related to the first user that is stored in the server.

### Appendix 14

A method executed by a computer including a processor and a memory, wherein the processor executes all the steps executed in the disclosure according to any one of Appendixes 1 to 13.

This allows the first user to initiate a call to a predetermined call destination identified based on a two-dimensional code and transmit additional information related to the call of the first user to the URL identified based on the two-dimensional code.

### Appendix 15

An information processing apparatus including a control unit and a storage unit, wherein the control unit executes all the steps executed in the disclosure according to any one of Appendixes 1 to 13.

This allows the first user to initiate a call to a predetermined call destination identified based on a two-dimensional code and transmit additional information related to the call of the first user to the URL identified based on the two-dimensional code.

### Appendix 16

A system comprising means for executing all the steps executed in the disclosure according to any of Appendixes 1 to 13.

This allows the first user to initiate a call to a predetermined call destination identified based on a two-dimensional code and transmit additional information related to the call of the first user to the URL identified based on the two-dimensional code.

### EXPLANATION OF REFERENCE NUMERALS

1: system, 10: server, 101: storage unit, 104: control unit, 106: input apparatus, 108: output apparatus, 20: first user terminal, 201: storage unit, 204: control unit, 206: input apparatus, 208: output apparatus, 30: second user terminal, 301: storage unit, 304: control unit, 306: input apparatus, 308 output apparatus, 50: voice server (PBX), 501: storage unit, 504: control unit, 506: input apparatus, 508: output apparatus, 60: CRM system, 601: storage unit, 604: control unit, 606: input apparatus, 608: output apparatus

1. An information processing apparatus for processing information on an interaction, the apparatus comprising:
a code reader; and
processing circuitry configured to:
read a two-dimensional code with the code reader and identify a predetermined URL based on the two-dimensional code;
initiate a call to a predetermined call destination associated with the identified predetermined URL; and
transmit additional information based on the identified predetermined URL, the additional information not including voice information related to a call of a first user of the information processing apparatus.

2. The information processing apparatus according to claim 1, wherein
the processing circuitry is configured to:
acquire, based on the two-dimensional code, embedded information not related to the first user embedded in the two-dimensional code, and
transmit the additional information based on the predetermined URL, the additional information including the embedded information.

3. The information processing apparatus according to claim 1, wherein
the processing circuitry is configured to transmit the additional information based on the predetermined URL, the additional information including:
first user information of the first user stored in a storage; and
generated information generated based on an operation of the first user at the information processing apparatus.

4. The information processing apparatus according to claim 1, wherein
the processing circuitry is configured to transmit the additional information in response to initiating the call.

5. The information processing apparatus according to claim 4, wherein
the processing circuitry is further configured to:
request the first user to agree to transmit the additional information before transmitting the additional information, and
initiate the call in response to reception of an operation indicating agreement from the first user.

6. The information processing apparatus according to claim 1, wherein
the processing circuitry is further configured to:
request the first user to agree to transmit the additional information before transmitting the additional information, and
initiate the call without transmitting the additional information, in response to reception of an operation indicating disagreement from the first user.

7. The information processing apparatus according to claim 3, wherein
the processing circuitry is further configured to:
request the first user to agree to transmit the additional information before transmitting the additional information, and
transmit the generated information without transmitting the first user information, in response to reception of an operation indicating disagreement from the first user.

8. The information processing apparatus according to claim 1, wherein
the processing circuitry is configured to initiate the call to the predetermined call destination without receiving an operation on the information processing apparatus by the first user, in response to the predetermined URL being identified.

9. An information processing apparatus for processing information on an interaction, the apparatus comprising:
processing circuitry configured to:
receive a call from a first user terminal;
receive additional information transmitted from the first user terminal, the additional information including embedded information not related to a first user and not including voice information related to the call of the first user of the first user terminal; and
store the additional information in association with attribute information of the first user, in response to the call being received from the first user terminal.

10. The information processing apparatus according to claim 9, wherein
the processing circuitry is configured to:
receive the additional information, the additional information including first user information of the first user, and generated information generated based on an operation of the first user at the first user terminal, and
store the first user information and the generated information in association with the attribute information of the first user.

11. The information processing apparatus according to claim 9, wherein
the processing circuitry is further configured to present the stored additional information to an operator different from the first user in association with the attribute information of the first user.

12. A system for processing information on an interaction, the system comprising:
a first user terminal including:
a code reader; and
first processing circuitry configured to:
read a two-dimensional code with the code reader and identify a predetermined URL based on the two-dimensional code;
initiate a call to a predetermined call destination associated with the identified predetermined URL; and
transmit additional information based on the identified predetermined URL, the additional information being related to the call of a first user of the first user terminal; and
a server including:
second processing circuitry configured to:
receive the call from the first user terminal;
receive the additional information transmitted from the first user terminal; and
store the additional information in association with attribute information of the first user of the first user terminal, in response to the call being received from the first user terminal.

13. The system according to claim 12, wherein
the second processing circuitry is further configured to present the stored additional information to an operator different from the first user in association with the attribute information.
